(19) United States
(12) Patent Application Publication
(10) Pub. No.: US 2003/0149591 A1
(43) Pub. Date: Aug. 7, 2003

(54) Deploying rules by policy management apparatus as a function of information concerning network equipment

(75) Inventor: Mark Koops, Montlhery (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/359,141

(22) Filed: Feb. 6, 2003

(30) Foreign Application Priority Data
Feb. 7, 2002 (FR) 02 01 500

(51) Int. Cl. G06F 17/60

(52) U.S. Cl. 705/1

(57) ABSTRACT

Policy management apparatus for deploying rules over a set of elements in a data network, in particular a telecommunications network, the rules enabling services to be implemented, wherein the apparatus has means giving it access to a database containing information about the set of network elements, and wherein deployment is performed as a function of said information.

The present invention relates to managing data networks such as telecommunications networks, and to managing the services implemented on such networks. More particularly, the invention relates to managing services by means of policy rules and to apparatus and to a method for facilitating implementation of such policy rules (which are referred to below, for simplicity, merely as “rules”).

### BACKGROUND OF THE INVENTION

Data networks can implement a very wide variety of services, requiring a very wide variety of capabilities from the elements of the network.

One network management function consists in determining which network elements can implement particular services, depending on the capabilities required by the services and the capabilities offered by each network element.

FIG. 1 shows a conventional situation.

A terminal X is connected to an access network N_{A} and seeks to establish a service session with a terminal Y connected to a core network N_{C}. Four routers, A, B, C, and D enable the access network N_{A} to be connected to the core network N_{C}.

Each router can implement a limited set of capabilities. Router A can implement capabilities F₁ (e.g. quality of service), F₂ (e.g. firewall type security), and F₃ (e.g. encryption of transmitted data). Router B can implement capabilities F₁ and F₂. Router C can implement capabilities F₁ and F₄ (e.g. network address translation (NAT)). Finally, router D can implement capabilities F₁ and F₂.

In order to implement a service, it is therefore necessary to select which routers are going to be used for conveying the data stream between terminals X and Y. To make this selection, it is necessary to compare the capabilities required by the service (e.g., F₁, F₂, and F₄) with the capabilities offered by the routers. In the situation illustrated by way of example, there are two possibilities: either routers C and B are selected, or else routers C and D.

In the state of the art, the selection is performed by an operator, by visually comparing the capabilities required by a service with a topological map of the network, which map includes the capabilities offered by the routers.

Once a selection has been made, it must be “provisioned”, i.e. the service manager apparatus must communicate the information necessary for implementing the service to the routers involved.

Thus, if routers C and B are selected, it is necessary to transmit the necessary information to these routers to enable them to implement the capabilities required by the service, i.e. F₁, F₂, and F₄.

This “provisioning” stage must be performed by transmitting appropriate rules.

For example, required capability F₂ can trigger the transmission to router B of a rule consisting in allowing data streams to pass only between 8h00 and 19h00.

In the prior art, service management apparatuses exist which are associated with databases storing information about the rules, about the capabilities of the network equipment and/or about the services to be implemented. This is the case of European patent application EP 1 026 867 filed by the company Nortel, for example.

However, at present, said service management apparatuses do not make it easy to match the capabilities offered by network equipment with the capabilities required by services. The manual comparison stage is penalizing insofar as firstly it is expensive in time, and secondly it is subject to operator error.

Similarly, there is no simple mechanism for matching the capabilities required by services with the rules to be implemented by network equipment.

### OBJECT AND SUMMARY OF THE INVENTION

The object of the invention is to mitigate this deficiency in the state of the art.

More precisely, the invention provides policy management apparatus for deploying rules over a set of elements in a data network, in particular a telecommunications network, the rules enabling services to be implemented. The policy management apparatus having means giving it access to a database containing information about:

said set of network elements;

said services; and

said rules.

These various kinds of information are matched with one another, and deployment is performed as a function of the information.

In an implementation of the invention, the policy management apparatus further includes means for storing the information in the database on the basis of data contained in registration messages received from network elements.

The registration messages may be forwarded via a policy decision point, for example.

In this way, matching can be performed automatically by the policy manager. This therefore makes it possible to mask from the operator all information concerning the network, its topology, and the capabilities offered by each of its elements. The task of the operator is thus greatly facilitated and risks of error are minimized.

### BRIEF DESCRIPTION OF THE DRAWINGS

The invention and its advantages appear more clearly from the following description given with reference to the accompanying figures.

FIG. 1, described above, illustrates an example of a data network.

FIG. 2 is a diagram showing the context in which the service management apparatus of the invention can be inserted.

FIG. 3 is a UML diagram representing the model that can be used by the service management apparatus.

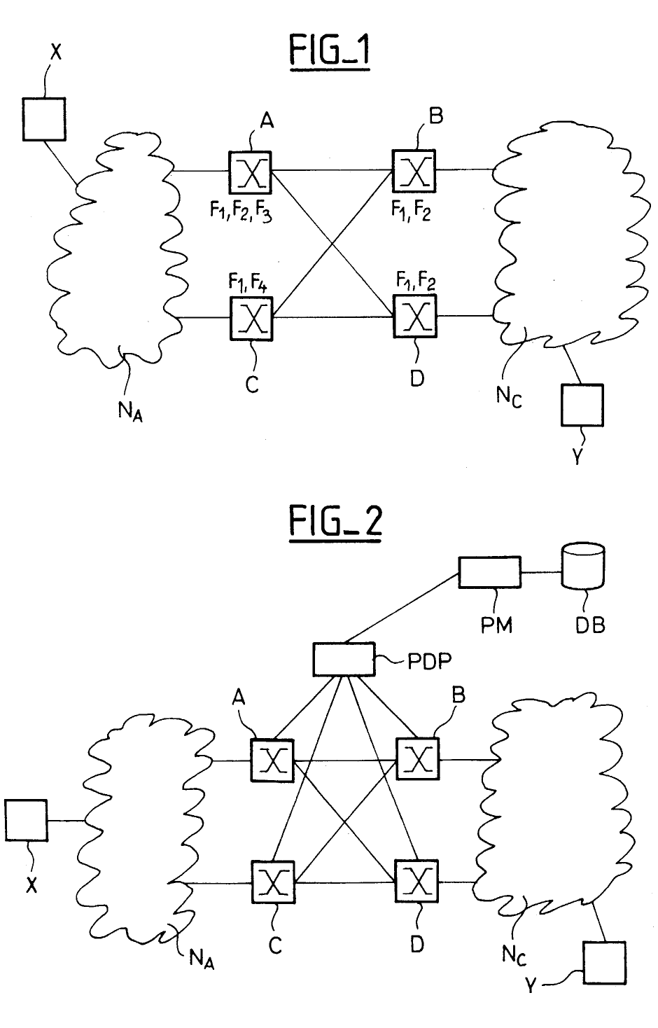

### MORE DETAILED DESCRIPTION

FIG. 2 shows two terminals X and Y connected respectively to an access network N_{A} and to a core network N_{C}. The two networks N_{A} and N_{C} are themselves interconnected via four routers, A, B, C, and D which are mutually interconnected.

At least these four network elements are associated with a policy manager PM via a policy decision point PDP.

The policy manager PM can form part of some wider service management apparatus. In practice, the policy manager need be no more than one of the capabilities of the service management apparatus, or it can be an independent module which, in association with other independent modules, provide its own contribution to the service management apparatus.

Similarly, the policy manager PM can be connected directly to the network elements A, B, C, and D, i.e. without passing via the policy decision point PDP.

When the network is put into operation, or when at least one or more of the network elements making it up are put into operation, the network elements send registration messages to the policy decision point PDP.

In an implementation of the invention, these registration messages contain data about network equipment capabilities.

For example, this data can concern:

the version of the software installed in the equipment;

the hardware version of the equipment;

the number of interfaces of the equipment; etc.

The policy decision point PDP collects this data and forwards it to the policy manager PM together with information relating thereto, e.g. its Internet Protocol (IP) address.

The policy manager PM or the service management apparatus containing it then stores this data in a database DB.

One of the main functions of the policy manager PM is to deploy rules to the various elements of the network, usually via policy decision points.

In the invention, the policy manager has means giving it access to the database DB which contains the information about the network elements. This information can be stored using the above-described method consisting in causing the data to be sent upwards by registration messages from the elements of the network, or by any other means (in particular manually when the network is configured).

In the invention, rule deployment is a function of this information. Thus, in order to determine which rules should be transmitted to which elements of the network, the policy manager PM consults the information contained in the database DB.

Such determination can be implemented in particular by matching:

capabilities offered by network elements (i.e. information contained in the database DB);

capabilities required by a service to be implemented; and

capabilities required to implement the rules.

To perform this matching, the policy manager PM can automatically determine which rules are appropriate for implementing the service in question, and the way in which the rules should be deployed.

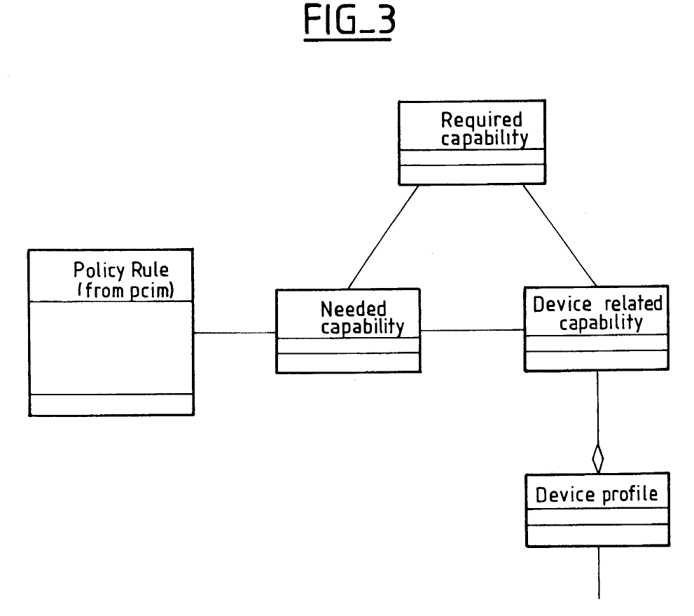

FIG. 3 is in the form of a unified modeling language (UML) diagram showing how this matching is implemented. Such a diagram can be understood by the person skilled in the art when writing a computer program for implementing the invention within the policy manager PM.

This UML diagram is made up of various boxes, each representing a class of objects.

The class “PolicyRule” represents the policy rules. They can be in accordance with RFC 3060 of the Internet Engineering Task Force (IETF) entitled “Policy Core Information Model” and published in February 2001.

These rules can be stored in a database (not shown in FIG. 2). Each rule is associated with a set of parameters: a flag indicates whether the rule is enabled, is a priority, is a list of conditions, is a list of actions to be triggered, . . . .

From these parameters, it is possible to extract the capabilities required for implementing each rule. These necessary capabilities are represented by the class “Needed Capability”.

Each rule is associated with at least one condition and at least one action. In order to implement the action, and even to determine the condition, the network element must possess the needed capabilities. Thus, for example, it is not possible to implement a network address translation rule on a router that does not possess Network Address Translation (NAT) functionality.

Furthermore, the “Required Capability” class represents the capabilities required for implementing services.

The class “Device Profile” presents the profiles of the various elements of the network. It can contain a step of parameters associated with these network elements. From these parameters it is possible to deduce the capabilities offered by the network elements. These capabilities on offer are represented by the class “Device Related Capability”.

The three classes “Device Related Capability”, “Required Capability”, and “Needed Capability” are interconnected in order to make it possible to implement the matching described above.

Thus, the relationship between the classes “Required Capability” and “Device Related Capability” can be used for a given service, for determining which network elements can implement them.

The relationship between “Device Related Capability” and “Needed Capability” can then be used to determine which rules need to be deployed towards these network elements.

What is claimed is:

1/ Policy management apparatus for deploying rules over a set of elements in a data network, in particular a telecommunications network, said rules enabling services to be implemented, wherein the apparatus has means giving it access to a database containing information about said set of network elements, about said services, and about said rules, these various kinds of information being matched with one another, and wherein deployment is performed as a function of said information.

2/ Policy management apparatus according to claim 1, further including means for storing said information in said database on the basis of data contained in registration messages received from network elements.

3/ Policy management apparatus according to claim 2, in which said registration messages are forwarded via a policy decision point.

4/ Policy management apparatus according to claim 1, in which matching is performed by means of a UML language diagram.
